(19) United States
(12) Patent Application Publication
(10) Pub. No.: US 2024/0273606 A1
(43) Pub. Date: Aug. 15, 2024

(54) COMPUTER SYSTEM AND METHOD FOR ASSISTING TENANT REGISTRATION

(71) Applicant: Hitachi, Ltd., Tokyo (JP)

(72) Inventors: Satoko IWASAWA, Tokyo (JP); Kenichiro YAMADA, Tokyo (JP)

(73) Assignee: Hitachi, Ltd., Tokyo (JP)

(21) Appl. No.: 18/567,605

(22) PCT Filed: Jan. 17, 2022
(86) PCT No.: PCT/JP2022/001473

§ 371 Date: Dec. 6, 2023

(30) Foreign Application Priority Data
Jun. 15, 2021 (JP) 2021-099404

(51) Int. Cl. G06Q 30/0601; G06Q 50/16

(52) U.S. Cl. CPC G06Q 30/0631; G06Q 50/16

(57) ABSTRACT

A computer system for assisting registration to a service for matching a tenant and a space, in which the computer system manages space features representing characteristics of the space, acquires account information for SNS used by the tenant from the tenant, accesses the SNS using the account information and extracts keywords included in post information as SNS information, estimates tenant attributes representing business characteristics of the tenant based on the SNS information, estimates sales when the space is used for each combination of the tenant attributes and the space features, and presents an estimation result of the sales for each space to the tenant.

### INCORPORATION BY REFERENCE

This application claims the priority of Japanese Patent Application No. 2021-099404 filed on Jun. 15, 2021, and the content thereof is incorporated into the present application by reference.

### TECHNICAL FIELD

The present invention relates to a system and method for assisting registration to a service that matches tenants and spaces.

### BACKGROUND ART

In recent years, for example, the technique described in PTL 1 is known as a matching system for matching a space managed by a commercial facility such as a mall with a business operator (tenant) who desires to open a store.

PTL 1 describes that “a content matching system selects booth candidates for recommendation based on a desired exhibition date and time of a booth input by the user, content keywords for a content to be exhibited at the booth, target customer attributes targeted by the user, content keywords of each booth stored in a matching data table, a booth exhibition date and time, the calculated number of customers for each booth, an attention level which is the ratio of people-of-interest who look at or stop by the booth when the content is exhibited to the total number of passersby, a people-of-interest attribute ratio such as gender and age of people-of-interest, a high interest rate which is the ratio of people-with-high-interest who enter the booth to the people-of-interest, and an attribute ratio of people-with-high-interest which is an attribute of people-with-high-interest”.

### CITATION LIST

### Patent Literature

PTL 1: JP2021-5233A

### SUMMARY OF INVENTION

### Technical Problem

At the stage of considering opening a store, it is time-consuming to input products or services handled by the tenant, the features of target customers, or the like, so there is a problem that it is difficult to encourage the use of a matching system.

An object of the invention is to provide a system and method for presenting information that encourages the use of a matching system.

### Solution to Problem

A representative example of the invention disclosed in the application is as follows. In other words, a computer system for assisting registration to a service for matching a tenant and a space used by the tenant, in which the computer system manages space features representing characteristics of the space, acquires account information for SNS used by the tenant from the tenant, accesses the SNS using the account information, extracts keywords included in post information as SNS information, estimates tenant attributes representing business characteristics of the tenant based on the SNS information, estimates sales when the space is used for each combination of the tenant attributes and the space features, and presents an estimation result of the sales for each space to the tenant.

### Advantageous Effects of Invention

According to one embodiment of the invention, it is possible to present information that encourages the use of a matching system. The problems, configurations, and effects other than those described above will be clarified by the description of the following embodiments.

### BRIEF DESCRIPTION OF DRAWINGS

FIG. 1 is a diagram illustrating an overview of the invention.

FIG. 2 is a diagram showing an example of the configuration of a system according to Embodiment 1.

FIG. 3 is a diagram showing an example of the hardware configuration of a registration assistance server according to Embodiment 1.

FIG. 4 is a diagram showing an example of information managed by an SNS information storage unit according to Embodiment 1.

FIG. 5 is a diagram illustrating an example of information managed by a tenant attribute storage unit according to Embodiment 1.

FIG. 6 is a diagram showing an example of information managed by a space information storage unit according to Embodiment 1.

FIG. 7 is a diagram showing an example of information managed by a store opening history information storage unit according to Embodiment 1.

FIG. 8 is a diagram showing an example of information managed by a store opening condition information storage unit according to Embodiment 1.

FIG. 9 is a diagram showing an example of information managed by a sales information storage unit according to Embodiment 1.

FIG. 10 is a diagram showing an example of information managed by a space feature information storage unit according to Embodiment 1.

FIG. 11 is a flowchart illustrating an example of a space feature information extraction process executed by an edge server according to Embodiment 1.

FIG. 12 is a flowchart illustrating an example of a tenant attribute estimation process executed by the registration assistance server according to Embodiment 1.

FIG. 13 is a flowchart illustrating an example of a tenant attribute update process executed by the registration assistance server according to Embodiment 1.

FIG. 14 is a flowchart illustrating an example of a sales estimation process executed by the registration assistance server according to Embodiment 1.

### DESCRIPTION OF EMBODIMENTS

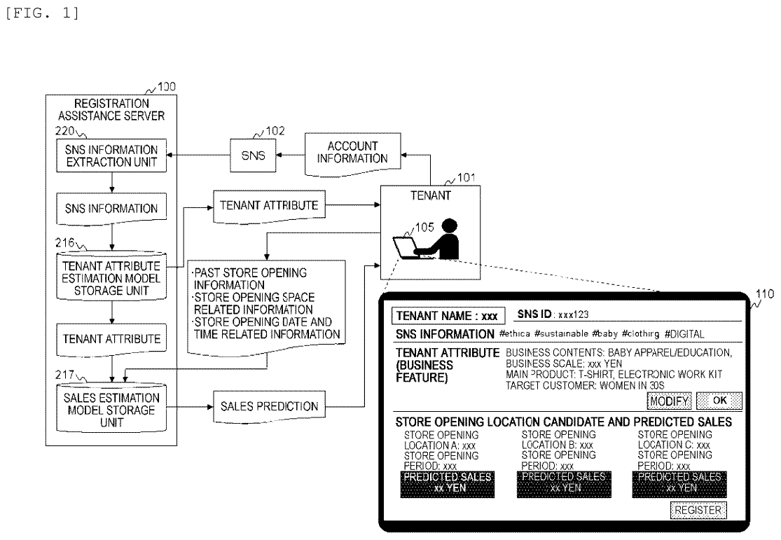

First, the concept of the invention will be described. FIG. 1 is a diagram illustrating an overview of the invention.

A system includes a registration assistance server 100, a tenant 101, and a social networking service (SNS) 102.

The tenant 101 represents a business operator (either an individual or a corporation) who desires to open a store. The tenant 101 uses a terminal 105 to input information to the registration assistance server 100 and also refers to information output from the registration assistance server 100. In the invention, the tenant 101 inputs account information for accessing the SNS 102, past store opening information, store opening condition information (store opening space related information and store opening date and time related information), and the like, and receives information regarding tenant attributes, space, and sales prediction presented from the registration assistance server 100.

The registration assistance server 100 is a system that assists registration of the tenant 101 in a matching system (not shown), estimates tenant attributes, and predicts sales when the tenant 101 opens a store in any space. Here, the tenant attributes are attributes that represent the business characteristics of the tenant 101, such as the products and services handled by the tenant 101, and a target customer group. The matching system is a system that matches the tenants 101 and the spaces.

The registration assistance server 100 includes an SNS information extraction unit 220, a tenant attribute estimation model storage unit 216, and a sales estimation model storage unit 217.

The SNS information extraction unit 220 extracts predetermined keywords as SNS information from the post information of the tenant 101 posted on the SNS 102 using account information. The SNS information is not limited to keywords. For example, the SNS information may be an image posted on the SNS 102 or information extracted from the image.

The tenant attribute estimation model storage unit 216 stores a tenant attribute estimation model. The tenant attributes are estimated by inputting the SNS information into the tenant attribute estimation model. The estimated tenant attributes are transmitted to the sales estimation model storage unit 217 and the terminal 105. The estimated tenant attributes are displayed on a screen 110 of the terminal 105. The screen 110 includes an operation button for modifying the tenant attribute and an operation button for confirming the tenant attribute.

The sales estimation model storage unit 217 stores a sales estimation model. Sales are estimated by inputting the tenant attributes into the sales estimation model. The sales estimation results are transmitted to the terminal 105. On the screen 110 of the terminal 105, spaces at which a large amount of sales are expected and estimated sales are displayed.

The registration assistance server 100 can reduce the effort of inputting information when registering the tenant 101 to the matching system, by estimating the tenant attributes from the post information on the SNS 102 using account information and presenting the estimated tenant attributes to the tenant 101. Since the space and a sales prediction are presented, the tenant 101 can perform a business simulation when using the matching system.

By increasing the number of the tenants 101 registered in the matching system, developers who provide spaces to tenants 101 have the advantage of being able to reach various tenants 101 more easily. The matching system operator has the advantage of being able to propose events and the like as well as the tenant attributes of various tenants 101 to the developer.

Embodiments of the invention will be described below with reference to the drawings. However, the invention is not limited to the contents described in the embodiment described below. It will be easily understood by those skilled in the art that the specific configuration can be changed to the extent that does not deviate from the idea or spirit of the invention.

In the configuration of the invention described below, the same or similar configurations or functions are denoted by the same reference numerals, and redundant explanations will be omitted.

The notations such as “first”, “second”, “third”, and the like in the specification are attached to identify constituent elements, and do not necessarily limit the number or order.

The positions, sizes, shapes, ranges, and the like of the respective components shown in the drawings and the like may not represent actual positions, sizes, shapes, ranges and the like to facilitate understanding of the invention. Therefore, the invention is not limited to the position, size, shape, range, and the like disclosed in the drawings and the like.

### Embodiment 1

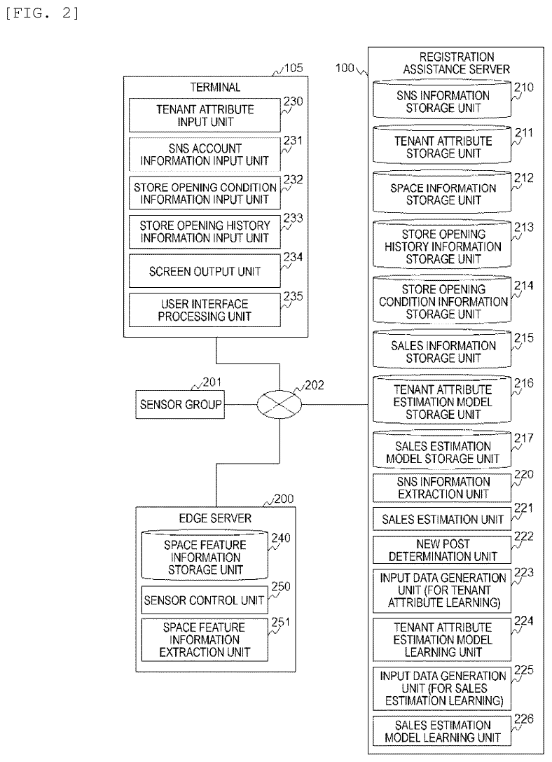

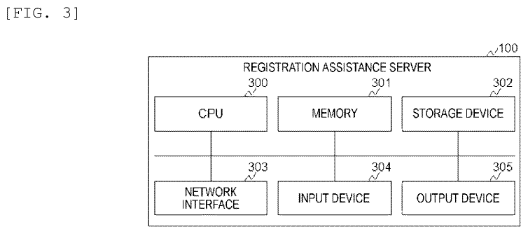

FIG. 2 is a diagram showing an example of the configuration of the system according to Embodiment 1. FIG. 3 is a diagram showing an example of the hardware configuration of the registration assistance server 100 according to Embodiment 1.

The system includes the registration assistance server 100, the terminal 105, an edge server 200, and a sensor group 201. The registration assistance server 100, the terminal 105, the edge server 200, and the sensor group 201 are connected to each other via a network 202. The network 202 is, for example, a wide area network (WAN) or a local area network (LAN), and the connection method may be either wired or wireless. The network connecting the registration assistance server 100 and the terminal 105, the network connecting the registration assistance server 100 and the edge server 200, and the network connecting the edge server 200 and the sensor group 201 may be different.

The registration assistance server 100 is a computer with a hardware configuration as shown in FIG. 3. Specifically, the registration assistance server 100 includes a CPU 300, a memory 301, a storage device 302, a network interface 303, an input device 304, and an output device 305. The hardware configuration of the registration assistance server 100 shown in FIG. 3 is an example and is not limited thereto. For example, the registration assistance server 100 may not include the input device 304 and the output device 305.

The CPU 300 is a calculation device that controls the entire registration assistance server 100, and executes programs stored in the memory 301. The CPU 300 operates as a functional unit (module) that implements a specific function by executing processes according to the programs. In the following description, when a process is described using a functional unit as a subject, it is indicated that the CPU 300 is executing the program that implements the functional unit.

The memory 301 is a storage device that stores programs executed by the CPU 300 and information used by the programs. The memory 301 is also used as a work area. The storage device 302 is a storage device that permanently stores data, such as a hard disk drive (HDD) and a solid state drive (SSD). The programs and information stored in the memory 301 may be stored in the storage device 302. Here, the CPU 300 reads programs and information from the storage device 302 and loads the programs and information into the memory 301.

The network interface 303 is an interface for communicating with an external device or an external system via a network. The input device 304 is a device for inputting data, commands, and the like to the registration assistance server 100, and is, for example, a keyboard, a mouse, a touch panel, or the like. The output device 305 is a device for outputting information, and is, for example, a display.

The hardware configurations of the terminal 105 and the edge server 200 are the same as the hardware configuration of the registration assistance server 100, so a description thereof will be omitted. The description returns to FIG. 2.

The registration assistance server 100 includes an SNS information storage unit 210, a tenant attribute storage unit 211, a space information storage unit 212, a store opening history information storage unit 213, a store opening condition information storage unit 214, a sales information storage unit 215, a tenant attribute estimation model storage unit 216, a sales estimation model storage unit 217, an SNS information extraction unit 220, a sales estimation unit 221, a new post determination unit 222, an input data generation unit (for tenant attribute learning) 223, a tenant attribute estimation model learning unit 224, an input data generation unit (for sales estimation learning) 225, and a sales estimation model learning unit 226.

The SNS information storage unit 210 manages the SNS information extracted from the post information on the SNS 102. The tenant attribute storage unit 211 manages the tenant attributes estimated from the SNS information. The space information storage unit 212 manages information regarding the spaces handled by the matching system. The store opening history information storage unit 213 manages information regarding sales or the like of past store openings (store opening history information). The store opening condition information storage unit 214 manages information related to store opening conditions (store opening condition information) such as the conditions of the space desired by the tenant 101. The sales information storage unit 215 manages the sales estimation results.

The tenant attribute estimation model storage unit 216 manages a model for estimating tenant attributes (tenant attribute estimation model). The tenant attribute estimation model of the present embodiment receives SNS information as input, and outputs tenant attributes. A model that receives information other than SNS information as input may be used. The sales estimation model storage unit 217 manages a model for estimating sales (sales estimation model). The sales estimation model of the present embodiment receives tenant attributes and space features as input, and outputs sales. A model that receives store opening conditions as input may be used.

The SNS information extraction unit 220 extracts the SNS information from the post information of the SNS 102. The sales estimation unit 221 estimates the sales using the sales estimation model. The new post determination unit 222 searches for new post information on the SNS 102.

The input data generation unit (for tenant attribute learning) 223 generates input data for learning the tenant attribute estimation model. For example, the input data generation unit 223 generates input data using information managed by the SNS information storage unit 210 and the tenant attribute storage unit 211. The tenant attribute estimation model learning unit 224 learns the tenant attribute estimation model using the input data, and outputs the tenant attribute estimation model that is a learning result to the tenant attribute estimation model storage unit 216.

The input data generation unit (for sales estimation learning) 225 generates input data for learning the sales estimation model. For example, the input data generation unit 225 generates input data using information managed by the space information storage unit 212 and the store opening history information storage unit 213. The sales estimation model learning unit 226 learns the sales estimation model using the input data, and outputs the sales estimation model that is a learning result to the sales estimation model storage unit 217.

Regarding each functional unit included in the registration assistance server 100, a plurality of functional units may be combined into one functional unit, or one functional unit may be divided into a plurality of functional units for respective functions.

The registration assistance server 100 may be a registration assistance system configured by a plurality of computers.

The terminal 105 is a terminal operated by the tenant 101, and includes a tenant attribute input unit 230, an SNS account information input unit 231, a store opening condition information input unit 232, a store opening history information input unit 233, a screen output unit 234, and a user interface processing unit 235.

The tenant attribute input unit 230 inputs contents to be modified and contents to be added of the tenant attributes to the registration assistance server 100. The tenant 101 refers to the tenant attributes estimated by the registration assistance server 100 and uses the tenant attribute input unit 230 to modify and add tenant attributes. The SNS account information input unit 231 inputs account information of the SNS 102 used by the tenant 101 into the registration assistance server 100. The store opening condition information input unit 232 inputs store opening condition information to the registration assistance server 100. The store opening history information input unit 233 inputs store opening history information to the registration assistance server 100. The screen output unit 234 outputs a screen. The user interface processing unit 235 performs processes related to a user interface.

Regarding each functional unit included in the terminal 105, a plurality of functional units may be combined into one functional unit, or one functional unit may be divided into a plurality of functional units for respective functions.

The sensor group 201 is a sensor group installed in a region in which the space exists, and acquires sensor data and the like regarding people using the space. The sensor group 201 acquires images, for example.

The edge server 200 analyzes and manages features related to the space. The edge server 200 includes a space feature information storage unit 240, a sensor control unit 250, and a space feature information extraction unit 251.

The space feature information storage unit 240 manages information regarding characteristics of the space (space feature information). In the present embodiment, information about people passing through or using the space is managed as a space feature. The sensor control unit 250 controls the sensor group 201. Note that the edge server 200 includes a storage unit that manages sensor data, but the unit is omitted. The space feature information extraction unit 251 extracts space feature information of each space by analyzing the sensor data, and outputs the space feature information to the space feature information storage unit 240.

Regarding each functional unit included in the edge server 200, a plurality of functional units may be combined into one functional unit, or one functional unit may be divided into a plurality of functional units for respective functions.

In the present embodiment, the registration assistance server 100 is configured to be able to grasp space features by communicating with the edge server 200, but the configuration is not limited thereto. For example, the edge server 200 may transmit space feature information to the registration assistance server 100 in advance.

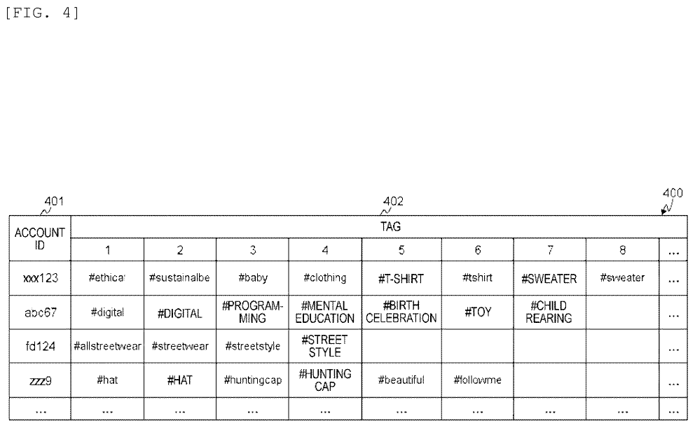

Next, information managed by the registration assistance server 100 and the edge server 200 will be explained using FIGS. 4 to 10.

FIG. 4 is a diagram showing an example of information managed by the SNS information storage unit 210 according to Embodiment 1.

The SNS information storage unit 210 manages a table 400 as shown in FIG. 4. The table 400 stores entries including account ID 401 and tag 402. There is one entry for one piece of account information. Fields included in the entry are not limited to those described above. The entry may not include any of the fields described above, or may include other fields.

The account ID 401 is a field that stores an account ID that is account information for accessing the SNS 102 used by the tenant 101. The tag 402 is a field group that stores hashtags that are SNS information extracted from post information on the SNS 102. The tag 402 includes a plurality of fields that store hashtags.

In the present embodiment, hashtags are extracted as SNS information, but the invention is not limited thereto. Words related to products, users, or the like may be extracted as SNS information.

The data format of the information managed by the SNS information storage unit 210 may be in a format other than a table. For example, CSV, XML, or the like may be used.

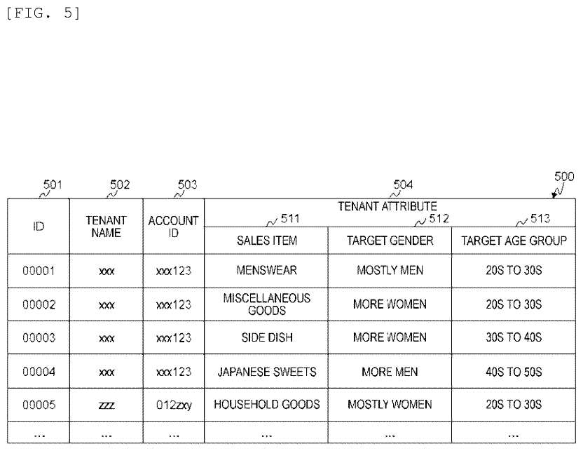

FIG. 5 is a diagram illustrating an example of information managed by the tenant attribute storage unit 211 according to Embodiment 1.

The tenant attribute storage unit 211 manages a table 500 as shown in FIG. 5. The table 500 stores entries including ID 501, tenant name 502, account ID 503, and tenant attribute 504. There is one entry for a combination of the tenant 101 and the tenant attributes. The fields included in the entry are not limited to those described above. The entry may not include any of the fields described above, or may include other fields.

The ID 501 is a field that stores identification information of the entries in the table 500. The tenant name 502 is a field that stores identification information of the tenant 101. In the present embodiment, the name of the tenant 101 is stored. The account ID 503 is the same field as the account ID 401. The tenant attribute 504 is a field group that stores tenant attributes of the tenant 101. The tenant attribute 504 includes a sales item 511, a target gender 512, and a target age group 513. The tenant attribute 504 may include fields other than those described above.

The data format of the information managed by the tenant attribute storage unit 211 may be in a format other than a table. For example, CSV, XML, or the like may be used.

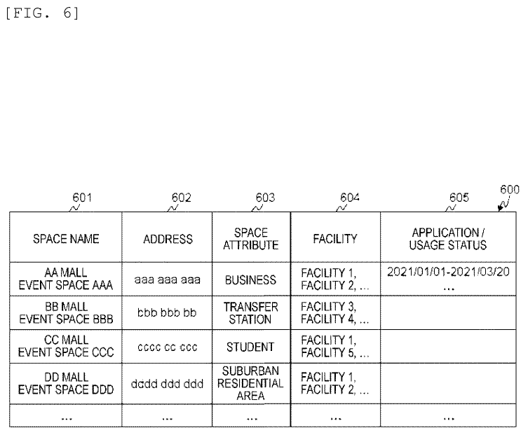

FIG. 6 is a diagram showing an example of information managed by the space information storage unit 212 according to Embodiment 1.

The space information storage unit 212 manages a table 600 as shown in FIG. 6. The table 600 stores entries including space name 601, address 602, space attribute 603, facility 604, and application/usage status 605. There is one entry for one space. The fields included in the entry are not limited to those described above. The entry may not include any of the fields described above, or may include other fields.

The space name 601 is a field that stores space identification information. In the present embodiment, the name of the space is stored. The address 602 is a field that stores information indicating the location where the space exists. In the present embodiment, the address of the facility that provides the space is stored. The space attribute 603 is a field that stores a usage mode and the like of the space. The facility 604 is a field that stores information regarding facilities that can be used or installed in the space. The application/usage status 605 is a field that stores application status and usage status of the space. For example, a usage period of the space, and the like are stored.

The data format of the information managed by the space information storage unit 212 may be in a format other than a table. For example, CSV, XML, or the like may be used.

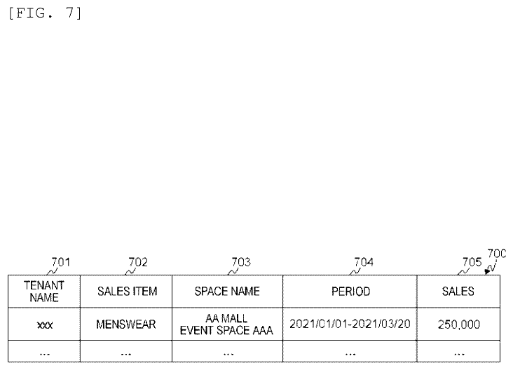

FIG. 7 is a diagram showing an example of information managed by the store opening history information storage unit 213 according to Embodiment 1.

The store opening history information storage unit 213 manages a table 700 as shown in FIG. 7. The table 700 stores entries including tenant name 701, sales item 702, space name 703, period 704, and sales 705. There is one entry for one store opening history. The fields included in the entry are not limited to those described above. The entry may not include any of the fields described above, or may include other fields.

The tenant name 701 is the same field as the tenant name 502. The sales item 702 is the same field as the sales item 511. The space name 703 is the same field as the space name 601. The period 704 is a field that stores a store opening period. The sales 705 is a field that stores sales.

The data format of the information managed by the store opening history information storage unit 213 may be in a format other than a table. For example, CSV, XML, or the like may be used.

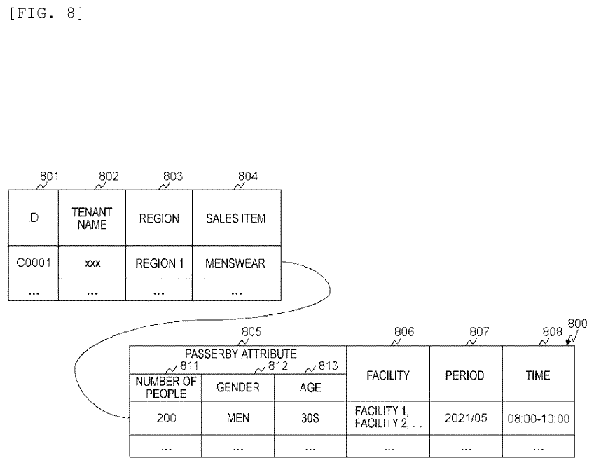

FIG. 8 is a diagram showing an example of information managed by the store opening condition information storage unit 214 according to Embodiment 1.

The store opening condition information storage unit 214 manages a table 800 as shown in FIG. 8. Due to the margin of the drawing, the table 800 is displayed in two stages. The table 800 stores entries including ID 801, tenant name 802, region 803, sales item 804, passerby attribute 805, facility 806, period 807, and time 808. There is one entry for a combination of the tenant 101 and the sales item. The fields included in the entry are not limited to those described above. The entry may not include any of the fields described above, or may include other fields.

The ID 801 is a field that stores identification information of entries in the table 800. The tenant name 802 is the same field as the tenant name 502. The region 803 is a field that stores a region in which the user desires to open a store. The region 803 stores the name, address, and the like of the region. The sales item 804 is a field that stores items to be sold or services to be provided.

The passerby attribute 805 is a group of fields that store desired space features. The passerby attribute 805 includes number of people 811, gender 812, and age 813. The passerby attribute 805 may include fields other than those described above. The number of people 811 is a field that stores the number of people passing through or using the space per unit time. The gender 812 is a field that specifies a gender distribution of people passing through or using the space. When the gender 812 is “men”, it indicates that it is desired that a large proportion of people passing through or using the space be men. The age 813 is a field that specifies the age distribution of people passing through or using the space. When the age 813 is “30s”, it indicates that it is desired that a large proportion of people passing through or using the space be in their 30s.

The facility 806 is a field that stores desired facilities. The period 807 is a field that stores a desired usage period of the space. The time 808 is a field that stores a usage time (business hours) of the desired space.

The data format of the information managed by the store opening condition information storage unit 214 may be in a format other than a table. For example, CSV, XML, or the like may be used.

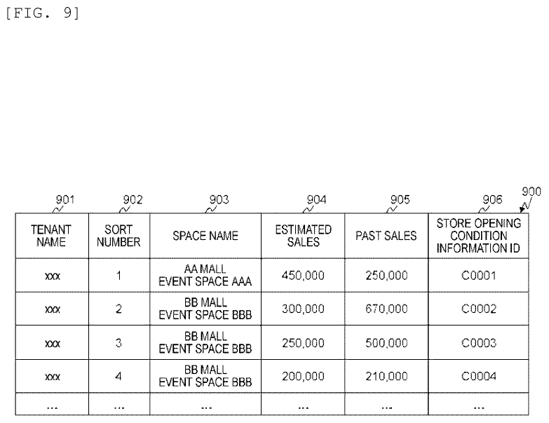

FIG. 9 is a diagram showing an example of information managed by the sales information storage unit 215 according to Embodiment 1.

The sales information storage unit 215 manages a table 900 as shown in FIG. 9. The table 900 is a field that stores entries including tenant name 901, sort number 902, space name 903, estimated sales 904, past sales 905, and store opening condition information ID 906. There is one entry for a combination of the tenant 101, space, and store opening conditions. The fields included in the entry are not limited to those described above. The entry may not include any of the fields described above, or may include other fields.

The tenant name 901 is the same field as the tenant name 502. The sort number 902 is a field that stores a display order of estimated sales. The space name 903 is the same field as the space name 601. The estimated sales 904 is a field that stores estimated sales. The past sales 905 is a field that stores sales in the past. The store opening condition information ID 906 is a field that stores identification information of an entry in the table 800. The store opening condition information ID 906 stores a value corresponding to the ID 801.

The data format of the information managed by the sales information storage unit 215 may be in a format other than a table. For example, CSV, XML, or the like may be used.

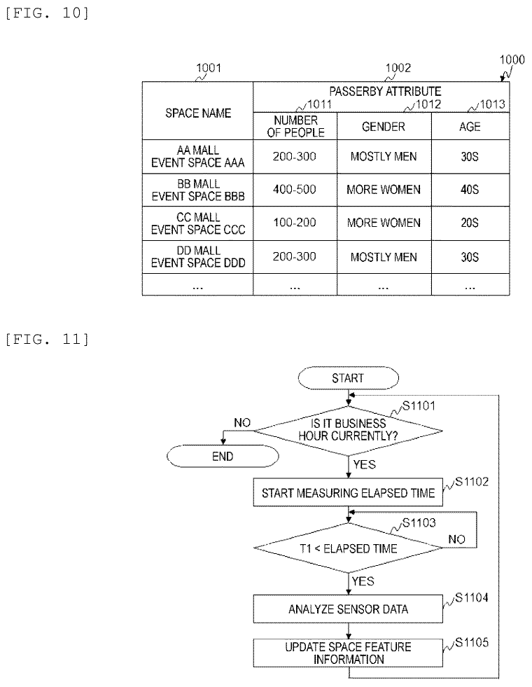

FIG. 10 is a diagram showing an example of information managed by the space feature information storage unit 240 according to Embodiment 1.

The space feature information storage unit 240 manages a table 1000 as shown in FIG. 10. The table 1000 is a field that stores entries including space name 1001 and passerby attribute 1002. There is one entry for one space. The fields included in the entry are not limited to those described above. The entry may not include any of the fields described above, or may include other fields.

The space name 1001 is the same field as the space name 601. The passerby attribute 1002 is a field group that stores the passerby attribute 1002 representing characteristics of a space. The passerby attribute 1002 includes number of people 1011, gender 1012, and age 1013. The number of people 1011 is a field that stores the number of people passing through or using the space per unit time. The gender 1012 is a field that stores the gender distribution of people passing through or using the space. The age 1013 is a field that stores the age distribution of people passing through or using the space.

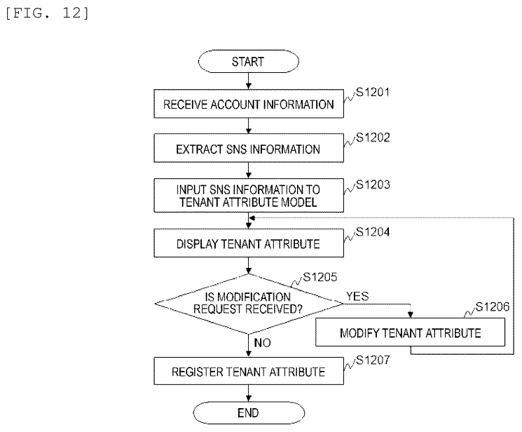

Next, the process executed in the system will be explained using FIGS. 11 to 14.

FIG. 11 is a flowchart illustrating an example of a space feature information extraction process executed by the edge server 200 according to Embodiment 1.

The edge server 200 starts the space feature information extraction process periodically or when receiving an execution instruction. In FIG. 11, a process executed for one space will be described. When there are a plurality of spaces, similar processes are performed for each space.

The space feature information extraction unit 251 determines whether the space is currently in business hours (step S1101).

When it is not determined that the space is currently in business hours, the space feature information extraction unit 251 ends the space feature information extraction process.

When it is determined that the space is currently in business hours, the space feature information extraction unit 251 starts measuring elapsed time (step S1102).

The space feature information extraction unit 251 determines whether the elapsed time is greater than a threshold T1 (step S1103). The threshold T1 is a value that is set in advance, and can be set to any value.

When the elapsed time is less than or equal to the threshold T1, the space feature information extraction unit 251 returns to step S1103 after a certain period of time has elapsed.

When the elapsed time is greater than the threshold T1, the space feature information extraction unit 251 analyzes the sensor data acquired from the sensor group 201 and outputs passerby attributes (step S1104). For example, the space feature information extraction unit 251 specifies the gender, age, and number of people passing through or using the space by performing a known image analysis.

The sensor data is acquired and managed by the sensor control unit 250.

The space feature information extraction unit 251 updates the space feature information (step S1105), and then returns to step S101. Here, the space feature information extraction unit 251 initializes the elapsed time.

Specifically, the space feature information extraction unit 251 outputs the space identification information and passerby attributes to the space feature information storage unit 240. The space feature information storage unit 240 searches for an entry in which the received space identification information is stored in the space name 1001. When there is such an entry, the space feature information storage unit 240 overwrites the passerby attribute 1002 of the entry with the received passerby attribute. When there is no such entry, the space feature information storage unit 240 adds an entry to the table 1000 and sets the received values in the space name 1001 and the passerby attribute 1002 of the entry.

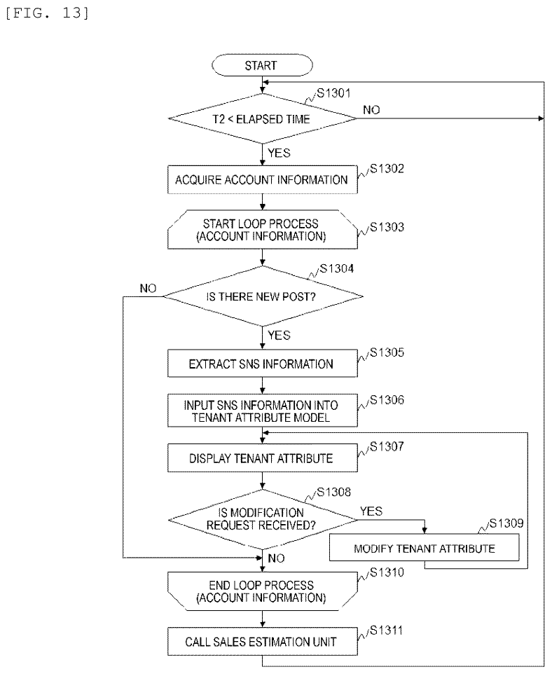

FIG. 12 is a flowchart illustrating an example of a tenant attribute estimation process executed by the registration assistance server 100 according to Embodiment 1. When receiving an operation from the terminal 105, the registration assistance server 100 starts a tenant attribute estimation process.

The SNS information extraction unit 220 presents a screen for inputting account information to the terminal 105, and waits for input of the account information.

The SNS information extraction unit 220 receives account information via the SNS account information input unit 231 of the terminal 105 (step S1201).

The SNS information extraction unit 220 uses the account information to access the SNS 102, and extracts the SNS information from the post information of the tenant 101 on the SNS 102 (step S1202). Here, the SNS information extraction unit 220 outputs the account information and the extracted SNS information to the SNS information storage unit 210. The SNS information storage unit 210 searches for an entry in which the received account information is stored in the account ID 401. When there is such an entry, the SNS information storage unit 210 overwrites the tag 402 of the entry with the received SNS information. When there is no such entry, the SNS information storage unit 210 adds an entry to the table 400, and sets the received values in the account ID 401 and tag 402 of the entry.

In the present embodiment, hashtags are extracted as SNS information, but keywords related to items to be handled and customers may be acquired as SNS information by using a known natural language processing technology.

The SNS information extraction unit 220 acquires tenant attributes by inputting the SNS information into the tenant attribute estimation model (step S1203).

The SNS information extraction unit 220 displays the estimated tenant attributes via the screen of the terminal 105 (step S1204), and waits for an operation by the tenant 101.

When receiving an operation of the tenant 101 via the tenant attribute input unit 230, the SNS information extraction unit 220 determines whether the operation is a modification request (step S1205). The modification request includes the contents to be modified.

When it is determined that the received operation is a modification request, the SNS information extraction unit 220 modifies the tenant attributes according to the modification request (step S1206), and then returns to step S1204.

Specifically, the SNS information extraction unit 220 outputs the account information and the contents to be modified of the tenant attributes to the tenant attribute storage unit 211. The tenant attribute storage unit 211 searches for an entry in which the received account information is stored in the account ID 503, and reflects the contents to be modified of the tenant attributes in the tenant attributes 504 of the entry.

When it is determined that the received operation is a completion request, the SNS information extraction unit 220 registers the tenant attributes (step S1207). Then, the SNS information extraction unit 220 ends the tenant attribute estimation process.

Specifically, the SNS information extraction unit 220 outputs identification information, account information, and tenant attributes of the tenant 101 to the tenant attribute storage unit 211.

When there is an entry in which the tenant name 502 is the identification information of the tenant 101 and the sales item 511 is a sales item included in the data, the tenant attribute storage unit 211 overwrites the tenant attribute 504 of the entry with the tenant attributes included in the data. When the above-described entry does not exist, the tenant attribute storage unit 211 adds an entry, sets identification information in the ID 501, sets the identification information and account information of the tenant 101 in the tenant name 502 and account ID 503, and sets the tenant attribute included in the data in the tenant attribute 504. The tenant attribute storage unit 211 starts measuring the elapsed time.

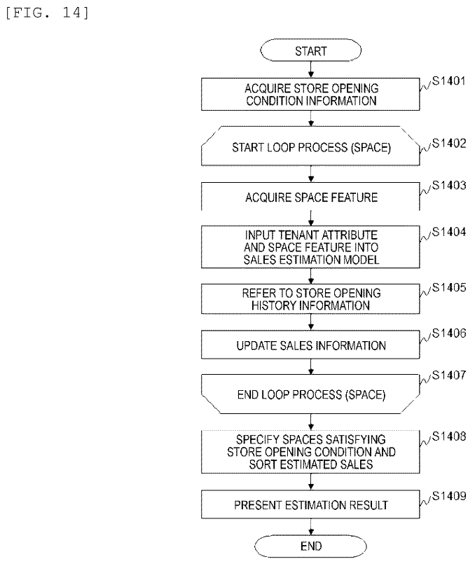

FIG. 13 is a flowchart illustrating an example of a tenant attribute update process executed by the registration assistance server 100 according to Embodiment 1. After being activated, the registration assistance server 100 starts a tenant attribute update process.

The tenant attribute storage unit 211 determines whether the elapsed time is greater than a threshold T2 (step S1301).

When the elapsed time is less than or equal to the threshold T2, the tenant attribute storage unit 211 returns to step S1301 after a certain period of time has elapsed.

When the elapsed time is greater than the threshold T2, the tenant attribute storage unit 211 calls the new post determination unit 222. The new post determination unit 222 accesses the SNS information storage unit 210 and acquires account information (step S1302).

The new post determination unit 222 starts a loop process for account information (step S1303). Specifically, the new post determination unit 222 selects one piece of account information from the acquired account information.

The new post determination unit 222 accesses the SNS 102 using the selected account information and determines whether there is new post information of the tenant 101 corresponding to the account information (step S1304). For example, the new post determination unit 222 determines whether there is any post information posted after the date and time obtained by subtracting the elapsed time from the current date and time.

When it is determined that there is no new post information of the tenant 101, the new post determination unit 222 proceeds to step S1310.

When it is determined that there is new post information of the tenant 101, the new post determination unit 222 calls the SNS information extraction unit 220. Here, the new post determination unit 222 outputs the selected account information to the SNS information extraction unit 220.

The SNS information extraction unit 220 uses the account information to access the SNS 102, and extracts the SNS information from the post information of the tenant 101 from the SNS 102 (step S1305). The process in step S1305 is the same as the process in step S1202.

The SNS information extraction unit 220 inputs the SNS information into the tenant attribute estimation model (step S1306) and acquires the tenant attributes. The process in step S1306 is the same as the process in step S1203. For the tenant attribute estimation, the previously extracted SNS information and the newly extracted SNS information are input.

The SNS information extraction unit 220 displays the estimated tenant attributes via the screen of the terminal 105 (step S1307), and waits for an operation by the tenant 101. The process in step S1307 is the same as the process in step S1204.

When receiving an operation of the tenant 101 via the tenant attribute input unit 230, the SNS information extraction unit 220 determines whether the operation is a modification request (step S1308). The modification request includes the contents to be modified. The process in step S1308 is the same as the process in step S1205.

When it is determined that the received operation is a modification request, the SNS information extraction unit 220 modifies the tenant attributes according to the modification request (step S1309), and then returns to step S1307. The process in step S1309 is the same as the process in step S1206.

When it is determined that the received operation is a completion request, the SNS information extraction unit 220 notifies the new post determination unit 222 of the completion of the process.

In step S1310, the new post determination unit 222 determines whether the process has been completed for all pieces of account information acquired in step S1302 (step S1310).

When it is determined that the process has not been completed for all pieces of account information, the new post determination unit 222 returns to step S1303 and executes the same processing.

When it is determined that the process has been completed for all pieces of account information, the new post determination unit 222 calls the sales estimation unit 221 (step S1311), and then returns to step S1301. Here, the new post determination unit 222 outputs the account information of the tenant 101 with a new post to the sales estimation unit 221.

By automatically updating tenant attributes and estimating sales based on the latest tenant attributes, it is possible to recommend spaces according to the current situation of the tenant 101.

When there is no tenant 101 with a new post, the new post determination unit 222 ends the process without calling the sales estimation unit 221.

FIG. 14 is a flowchart illustrating an example of a sales estimation process executed by the registration assistance server 100 according to Embodiment 1.

When receiving an execution instruction from the terminal 105 or when being called by the new post determination unit 222, the registration assistance server 100 starts a sales estimation process. In FIG. 14, the sales estimation process that is executed when the execution instruction is received from the terminal 105 will be described.

The sales estimation unit 221 acquires the store opening condition information of the tenant 101 from the store opening condition information storage unit 214 (step S1401). Specifically, the sales estimation unit 221 outputs the identification information of the tenant 101 to the store opening condition information storage unit 214. The store opening condition information storage unit 214 searches for an entry in which the received identification information of the tenant 101 is stored in the tenant name 802, and outputs the entry to the sales estimation unit 221.

Here, it is assumed that the store opening condition information has been input before starting the sales estimation process. The sales estimation unit 221 may prompt the tenant 101 to input store opening condition information here.

The sales estimation unit 221 starts a loop process for space (step S1402). Specifically, the sales estimation unit 221 acquires space information from the space information storage unit 212, and selects one piece of space information from among the acquired space information.

The sales estimation unit 221 acquires the space feature of the selected space from the space feature information storage unit 240 of the edge server 200 (step S1403).

Specifically, the sales estimation unit 221 transmits an acquisition request including the space identification information to the edge server 200. The space feature information storage unit 240 searches for an entry in which the space identification information included in the acquisition request is stored in the space name 1001, and transmits a response containing the value stored in the passerby attribute 1002 of the searched entry.

The sales estimation unit 221 obtains estimated sales by inputting the tenant attributes and the space features into the sales estimation model (step S1404).

The sales estimation unit 221 refers to the store opening history information (step S1405).

Specifically, the sales estimation unit 221 outputs the space identification information and the sales item included in the store opening condition information to the store opening history information storage unit 213.

The store opening history information storage unit 213 searches for an entry in which the combination of values of the sales item 702 and space name 703 matches the received combination of the sales item and the space identification information. When there is such an entry, the store opening history information storage unit 213 outputs the value stored in the sales 705 of the entry to the sales estimation unit 221 as a response. When there is no such entry, the store opening history information storage unit 213 outputs the fact that such entry does not exist to the sales estimation unit 221 as a response.

Only the past sales of the tenant 101 to be processed may be acquired. Here, the sales estimation unit 221 may output the identification information of the tenant 101, the space identification information, and the sales item to the store opening history information storage unit 213.

The sales estimation unit 221 updates sales information (step S1406). Specifically, the sales estimation unit 221 outputs the identification information of the tenant 101, the space identification information, the identification information of the store opening condition information, estimated sales, and past sales to the sales information storage unit 215.

The sales information storage unit 215 searches for an entry in which the combination of values of the tenant name 901, the space name 903, and the store opening condition information ID 906 matches the received combination of the identification information of the tenant 101, the space identification information, and the identification information of the store opening condition information. When there is such an entry, the sales information storage unit 215 overwrites the estimated sales 904 of the entry with the estimated sales, and overwrites the past sales 905 with the past sales. Here, the sort number 902 is deleted. When there is no such entry, the sales information storage unit 215 adds an entry, and sets the received values in the tenant name 901, the space name 903, the estimated sales, the past sales 905, and the store opening condition information ID 906 of the entry.

The sales estimation unit 221 determines whether the process has been completed for all spaces (step S1407).

When it is determined that the process has not been completed for all spaces, the sales estimation unit 221 returns to step S1402 and executes the same process.

When it is determined that the process has been completed for all spaces, the sales estimation unit 221 specifies spaces that satisfy the store opening conditions, and sorts the entries in the table 900 corresponding to the specified spaces in descending order of estimated sales (step S1408).

Specifically, the sales estimation unit 221 specifies spaces whose space features match or are similar to the passerby attributes included in the store opening condition information. The sales estimation unit 221 acquires entries corresponding to the specified spaces from the sales information storage unit 215, sorts the acquired entries in descending order of the estimated sales, and outputs a sort result to the sales information storage unit 215.

The sales information storage unit 215 sets a value in the sort number 902 of the entry corresponding to the specified space, based on the sort result.

The sales estimation unit 221 presents the estimation result to the terminal 105 (step S1409), and ends the sales estimation process.

Specifically, the sales estimation unit 221 acquires a predetermined number of entries from the sales information storage unit 215 in ascending order of the sort number, and presents the estimation result to the terminal 105 based on the entries. The estimation result may include the space features.

Through the above processing, the registration assistance server 100 can present a space that matches the conditions desired by the tenant 101 and a sales prediction when the tenant 101 opens a store in the space.

The sales estimation unit 221 may specify a space that matches the store opening condition information before starting the space loop process and execute the loop process for the specified space. Then, in step S1408, the sales estimation unit 221 performs only sorting based on the estimated sales. It becomes possible to propose a more effective space to the tenant 101.

In step S1408, the sales estimation unit 221 may perform sorting without limiting the space. Here, it is not necessary to input store opening conditions. It becomes possible to present estimated sales while reducing input burden on the tenant 101.

When being called by the new post determination unit 222, the sales estimation unit 221 executes the process shown in FIG. 14 for the tenant 101 with a new post. Here, the estimation results may not be presented to the terminal 105.

The registration assistance server 100 executes the learning process of the tenant attribute estimation model and the learning process of the sales estimation model at any timing. Since a known learning method may be used for the model, detailed explanation will be omitted.

As described above, according to the present embodiment, the tenant 101 can know the space with a high store opening effect and the estimated sales when the space is used, by inputting account information. The tenant 101 can perform a business simulation when using the matching system.

By increasing the number of tenants 101 registered in the matching system, developers have the advantage of being able to reach various tenants 101 more easily. The matching system operator has the advantage of being able to propose events and the like as well as the tenant attributes of various tenants 101 to the developer.

Note that the invention is not limited to each of the above-described embodiments, and various modifications are included. For example, the above embodiment describes the configuration in detail to explain the invention in an easy-to-understand manner, and is not necessarily limited to those having all the configurations described. With respect to a part of the configuration of each of the embodiments, addition, deletion, and replacement of another configuration can be performed.

Each of the above-described configurations, functions, processing units, processing means, and the like may be partially or entirely implemented by hardware, for example, by designing an integrated circuit. The invention can also be implemented by software program code that implements the functions of the embodiment. Here, a computer is provided with a storage medium storing the program code, and a processor included in the computer reads the program code stored in the storage medium. Here, the program code itself read from the storage medium implements the functions of the above-described embodiment, and the program code itself and the storage medium storing the program code configure the invention. As examples of storage media for supplying such program code, flexible disks, CD-ROMs, DVD-ROMs, hard disks, solid state drives (SSDs), optical disks, magneto-optical disks, CD-Rs, magnetic tapes, nonvolatile memory cards, ROMs, or the like are used.

The program code that implements the functions described in the present embodiment can be implemented in a wide range of programs or script languages such as assembler, C/C++, perl, Shell, PHP, Python, and Java.

By distributing the program code of the software that implements the function of the embodiment via a network and storing the program code in a storage means such as a hard disk or memory of a computer or a storage medium such as a CD-RW or CD-R, a processor included in the computer may read and execute the program code stored in the storage means or the storage medium.

In the above-described embodiment, the control lines and the information lines which are considered to be necessary for explanation are indicated, and not all control lines and information lines are necessarily indicated on the product. All configurations may be interconnected.

1. A computer system for assisting registration to a service for matching a tenant and a space used by the tenant, wherein the computer system
manages space features representing characteristics of the space,
acquires account information for SNS used by the tenant from the tenant,
accesses the SNS using the account information, and extracts keywords included in post information as SNS information,
estimates tenant attributes representing business characteristics of the tenant based on the SNS information,
estimates sales when the space is used for each combination of the tenant attributes and the space features, and
presents an estimation result of the sales for each space to the tenant.

2. The computer system according to claim 1, wherein the computer system
extracts hashtags as the SNS information.

3. The computer system according to claim 1, wherein the computer system
extracts words extracted by performing natural language processing on the post information as the SNS information.

4. The computer system according to claim 1, wherein the computer system
stores a sales prediction model generated by machine learning, and
estimates sales by inputting the tenant attributes and the space features into the sales prediction model.

5. The computer system according to claim 1, wherein the computer system
stores a tenant attribute estimation model generated by machine learning, and
estimates the tenant attributes by inputting the SNS information into the tenant attribute estimation model.

6. The computer system according to claim 1, further comprising:
a storage unit that manages the SNS information and the estimation result of the sales, wherein the computer system
determines whether there is new post information on the SNS,
extracts new SNS information from the new post information and stores the extracted new SNS information in the storage unit when there is the new post information on the SNS, and
estimates the sales for each space using the SNS information of the tenant stored in the storage unit, and stores the estimated sales in the storage unit.

7. The computer system according to claim 1, wherein the computer system
receives input of store opening conditions from the tenant, and
presents an estimation result of the sales of the space that satisfies the store opening conditions.

8. The computer system according to claim 1, wherein the computer system
presents the estimation result of the sales together with the space features of the space.

9. A method for assisting tenant registration to a service for matching tenant and a space used by the tenant executed by a computer system,
the computer system
configured by at least one computer including a processor, a storage device connected to the processor, and a network interface connected to the processor, and
managing space features representing characteristics of the space,
the method for assisting tenant registration comprising:
a first step in which the at least one computer acquires account information of SNS used by the tenant from the tenant;
a second step in which the at least one computer accesses the SNS using the account information and extracts keywords included in post information as SNS information;
a third step in which the at least one computer estimates tenant attributes representing business characteristics of the tenant based on the SNS information;
a fourth step in which the at least one computer estimates sales when the space is used for each combination of the tenant attributes and the space features; and
a fifth step in which the at least one computer presents an estimation result of the sales for each space to the tenant.

10. The method for assisting tenant registration according to claim 9, wherein
the second step includes a step in which the at least one computer extracts hashtags as the SNS information.

11. The method for assisting tenant registration according to claim 9, wherein
the second step includes a step in which the at least one computer extracts words extracted by performing natural language processing on the post information as the SNS information.

12. The method for assisting tenant registration according to claim 9, wherein
the computer system stores a sales prediction model generated by machine learning, and
the fourth step includes a step in which the at least one computer estimates sales by inputting the tenant attributes and the space features into the sales prediction model.

13. The method for assisting tenant registration according to claim 9, wherein
the computer system stores a tenant attribute estimation model generated by machine learning, and
the third step includes a step in which the at least one computer estimates the tenant attributes by inputting the SNS information into the tenant attribute estimation model.

14. The method for assisting tenant registration according to claim 9, wherein
the computer system includes a storage unit that manages the SNS information and the estimation result of the sales,
the method for assisting tenant registration further comprising:
a step in which the at least one computer determines whether there is new post information on the SNS;
a step in which the at least one computer extracts new SNS information from the new post information and stores the extracted new SNS information in the storage unit when there is the new post information on the SNS, and
a step in which the at least one computer estimates the sales for each space using the SNS information of the tenant stored in the storage unit and stores the estimated sales in the storage unit.

15. A computer system for assisting with registration to a service for matching a tenant and a space used by the tenant, wherein the computer system
manages space features representing characteristics of the space,
acquires account information for SNS used by the tenant from the tenant,
accesses the SNS using the account information and extracts keywords included in post information as SNS information,
estimates tenant attributes representing business characteristics of the tenant based on the SNS information,
receives input of store opening conditions from the tenant, and
estimates sales when the space is used for each combination of the tenant attributes and the space features of the space that corresponds to the input of the store opening conditions, and
presents an estimation result of the sales for each space to the tenant.
